(19) United States
(12) Patent Application Publication
(10) Pub. No.: US 2007/0017418 A1
(43) Pub. Date: Jan. 25, 2007

(54) Magnesium cementitious composition

(76) Inventor: Andrew C. Dennis, Las Vegas, NV (US)

Correspondence Address: GREGORY J. NELSON, 3333 E. CAMELBACK ROAD, SUITE 212, PHOENIX, AZ, 85018, US

(21) Appl. No.: 11/492,564

(22) Filed: Jul. 24, 2006

Related U.S. Application Data
(60) Provisional application No. 60/702,678, filed on Jul. 25, 2005.

(51) Int. Cl. C04B 9/00; C04B 12/00

(52) U.S. Cl. 106/685; 106/689; 106/688; 106/687

(57) ABSTRACT

A cementitious product for applications such as stucco, plaster coating, fireproof coatings, casting/molding applications and flooring. The product is a blend of magnesium oxide and magnesium chloride. Suitable fillers such as bottom ash, fly ash, clinker and other pulverized materials may be added. Fibrous materials, foaming agents and surfactants may also be added to achieve product characteristics for specific application. Processes for blending the selected ingredients are also disclosed.

### CROSS REFERENCE IS MADE TO RELATED APPLICATION

This application is based on U.S. Provisional Patent Application Ser. No. 60/702,678 filed Jul. 25, 2005, of the same title.

### FIELD OF THE INVENTION

The present invention relates to a magnesium cementitious composition having enhanced characteristics and more particularly to a cement composition containing magnesium oxide and magnesium chloride hexahydrate which may be modified by other materials to obtain a product particularly suitable for surface applications including, but not limited to, plaster coating, fireproof coatings, casting/molding applications and flooring applications.

### BACKGROUND OF THE INVENTION

The term “cement” generally means a finely ground powder which in the presence of an appropriate quantity of water will harden and adhere to a suitable aggregate, thus binding it into a hard agglomeration. One of the most common cements is Portland cement which is made by finely grinding limestone and clay or shale and calcining by adding some gypsum. The mixture obtained after calcining is known as “clinker” and is further processed by grinding along with the addition of material such as gypsum. Thus, the resulting Portland cement, when mixed with water and aggregate sets to a concrete.

In addition to Portland cement, there are other types of cement such as magnesium cement. The most common type of magnesium cement is Sorel cement. In the production of Sorel cement, high grade magnesite or magnesium carbonate is calcined to form reactive magnesium oxide (MgO). Calcining is carried out at specific temperatures so that reactive or caustic magnesium is produced. The caustic magnesium oxide reacts at ambient temperature with moderately concentrated solutions of magnesium chloride to produce Sorel cement. In some instances, a magnesium sulfate or phosphate may be substituted for magnesium chloride to produce cement. Sorel cements are widely used but may have certain limitations. Sorel cements are generally not particularly resistant to moisture and may be reactive with certain types of metals.

Therefore, in order to modify or enhance the characteristics of Sorel cement, various methods have been employed. The following are representative.

U.S. Pat. No. 3,951,888 discloses a method of making a foam fireproof product of magnesium oxychloride cement having fire-resistant characteristics. A porous substrate is impregnated with a foaming mixture of magnesium chloride and magnesium oxide and a frothing agent in water.

U.S. Pat. No. 4,209,339 discloses a Sorel cement composition in which ethylsilicate or a premix of magnesium chloride and magnesium oxide is added to the magnesium oxide chloride hydrate mixture followed by subsequent reaction in curing.

U.S. Pat. No. 5,004,505 describes a cement composition for use in repairing concrete surfaces for casting as well as usable as a coating with stucco. A small amount of acid is added to the cement and a brine solution such as brine from the Great Salt Lake is the preferred source of magnesium chloride.

U.S. Pat. No. 5,049,197 relates to a settable magnesium cement composition for floor leveling having a two part mix. The first part includes magnesium oxide while the second part includes magnesium chloride and a particulate fibrous material compound which preferably is fibrous long strand sawdust.

U.S. Pat. No. 4,352,694 relates to a process for producing magnesium oxychloride hydrate cements which involves forming a mixture of water, magnesium chloride, hydrated magnesium oxide and which a minor portion of the magnesium oxide is treated to render it substantially unreactive with the magnesium chloride.

### BRIEF SUMMARY OF THE INVENTION

The present invention relates to a cementitious product which is particularly useful for surface applications such as flooring applications, plaster applications, fireproof coatings, and for use as stucco with high impact and even ballistic resistance due to its enhanced physical characteristics including enhanced compressive and flexural strength, enhanced high early compressive strength, water resistance, and shrink resistance. These results may be achieved as in most instances with a single or one coat application. The composition, according to the present invention, incorporates magnesium oxide in dry powder form and magnesium chloride hexahydrate in dry crystal form or pulverized powder which are blended with a suitable filler such as silica sand, pulverized bottom ash, fly ash, also pulverized foundry clinker, sand, pulverized rock and stone and other pulverized recycled materials such as concrete in which the lime is neutralized or removed. By pulverizing foundry clinker and bottom ash as opposed to using fly ash, the resulting pulverized powder product is considerably harder and less reactive than fly ash. Due to the physical and molecular structure of the pulverized materials, the resulting product has enhanced strength, water resistance and shrink resistance. Pulverized bottom ash is essentially fused silica and carbon, crude glass would be a close comparison. This hard, pulverized material is sized down to specific sieve sizes similar to fly ash and sand but is significantly denser and stronger which yields a harder mix design and end product. The fines fill voids within the mix design and create an exceptionally dense and strong mix. With increased densities also comes increased permeability and waterproofing. Bottom ash used solely as filler can yield compressive strengths exceeding 9,000 psi with very high ratios of ash to cement, untypical to Portland based cements and previous Sorel type cements. The use of ash also relates to fire resistance as the materials have already been burned and are noncombustible.

Additives such as fibrous materials and foaming agents can be added to enhance or modify the composition for particular applications. Representative fiber materials may be glass fibers, polypropylene, polyolefin and metal fibers, recycled carpet fibers, fibers from agricultural products including bagasse from sugar cane, fibers of jute, hemp, kenaf, grasses and long chain fibers are usable and well suited to this form of Magnesium cement. Filler materials may consist of silica sand or ash such as bottom ash, clinker ash or fly ash residues from the incineration of coal.

The resulting composition, when mixed very accurately with proportioned water and properly applied to a surface, exhibits reduced shrinking and cracking and high tensile strength making it an excellent product for flooring, plaster coatings and stucco applications. The resulting product will generally cure within a period of 1 to 5 days, contrasted to the curing time for Portland cement which typically is 28 days. The resulting composition, when mixed with water, has the ability to bond to various surfaces, including, but not limited to cement, masonry, wood, existing stucco surfaces, or new stucco surfaces which are applied to a mesh and insulation panels. The resulting composition can be mixed to achieve compressive strengths exceeding 8,000 PSI. Conventional Portland based cement stucco products achieve compressive strengths ranging from 500 to 1,800 PSI and Portland based flooring products typically achieve compressive strengths ranging from 2,000 to 4,500 PSI. Another advantage of the composition of the present invention is that it can be produced economically and utilizes inexpensive materials such as recycled waste ash, often available for little or no cost from coal fired power generation stations and considered as a landfill clean up, also sand or silt recovered by dredging river beds or even sea water harbors for filler materials to achieve desired characteristics. The addition of fillers, particularly clinker ash, can result in a cured concrete exhibiting high tensile and compressive strength.

The principal components are calcined magnesite (magnesium oxide) which is a dry powder. The second principal ingredient is the hydrated form of magnesium chloride, magnesium chloride hexahydrate in pulverized powder or dry crystal form and of high purity. The magnesium chloride hexahydrate may be obtained from various sources, but it has been found that lake brine is a preferred source of this substance. Magnesium chloride hexahydrate may also be produced by processing magnesium chloride flakes obtained from sea water.

The basic components and composition described above may be combined in various manners with binders and fillers to produce various products. The following are specific examples of various compositions and the various modifications of these compositions:

### EXAMPLE I

| | |
|---|---|
| Product name | Stucco, Plaster, Casting and Flooring Applications |
| Binder ingredients | 1. Calcined magnesite Magnesium oxide) |
| | (dry powder - between approximately 87%-97% purity with an |
| | approximate sieve size of 325 mesh) |
| | 2. Magnesium chloride hexahydrate |
| | (dry crystal form or pulverized crystals between approximately |
| | 46% - 505 MgCl purity to form a powder) |
| Filler materials | Blended silica sand specifically proportioned and classified into |
| | specific portions of 16, 30, 60 and 90 grit sizes for stuccos and |
| | flooring. In addition, blended silica sand specifically proportioned |
| | and classified into specific portions of pulverized sand and 60 and |
| | 90 grit sizes for smooth interior plaster finishes, casting material |
| | and flooring. |
| Fiber materials | E-glass fiber - “E-glass” is a particular grade or type of fiberglass |
| | produced by Nippon Electric Glass Company and others. |
| | Alkali Resistant fiber - Alkali resistant glass fiber is a particular |
| | type of glass fiber produced by Nippon Electric Glass Company |
| | and others. |
| | Kenaf, jute or hemp natural fibers from 1 mm to 10 mm in length, |
| | Polypropylene fiber |
| | Polyolefin fiber |
| | Different fibers or combinations of fibers are used depending on |
| | the desired properties of the mix. The particular fiber or blend of |
| | fibers impacts the workability of the material, the crack resistance |
| | of the material, and the flexural strength of the material. |
| Manufacturing | 1. Silica sand is pulverized and or blended and prepared to |
| process | specific sieve specs. |
| | 2. Magnesium oxide (MgO) is blended with silica sand at a |
| | ratio of 2.0 to 10.0 parts sand to 1.0 parts MgO. |
| | 3. Magnesium chloride hexahydrate (MgCl) is blended to the |
| | mix at a ratio of 1.0 parts MgO to 0.6 parts MgCl. |
| | 4. A single type of fiber or blend of fibers (as noted above) are |
| | blended with the mix at a ratio between 99.75% StuccoMax |
| | mix to 0.25% fiber and 91.0% StuccoMax mix and 9.0% |
| | fiber based on weight. |
| | 5. Each 50 lb. bag of product requires approximately 7.2 lbs of |
| | potable water to be mixed thoroughly to the mix on site. |
| | The ingredients are stored in silos or are suspended in super sacks |
| | or bulk bags from weight loss metered machines that dose and |
| | mechanically move the materials that deliver the dry materials to a |
| | mixer. After appropriate mixing, fiber is blended into the mix as it |
| | is being directed into bags. The bags are sealed for shipping and |
| | delivery to customers. Potable water is mixed with the product on |
| | site by the customer. |
| Product | 1. Interior and exterior applications. |
| advantages | 2. High tensile strength allows it to be applied and stick to |
| | numerous substrates. |
| | 3. Can be mixed to achieve over 8,000 PSI (Compressive |
| | Strength) rather than 400 to 1,800 PSI, typical of |
| | conventional stucco products. The product also has a |
| | flexural strength of over 2500 psi (ASTM C293) and a |
| | bond strength of over 4500 psi (ASTMC-882-99). Water |
| | absorption (ASTM C-20) of about 5% to 7%. Water |
| | absorption and freeze thaw (ASTM C-62) about 3% with |
| | no checking, splitting or cracking at 300 cycles. |
| | 4. When properly applied, has significantly less shrinking and |
| | cracking than traditional stucco products. |
| | 5. When properly applied, has a workable curing time of |
| | between one and four hours. |
| | 6. When properly applied, can be sprayed or troweled as a |
| | true one-coat application (rather than 2 or 3 coats for most |
| | traditional stucco products) for smooth and textured |
| | finishes. |

### EXAMPLE II

| | |
|---|---|
| Product name | Environmental Stucco, Plaster, Casting and Flooring |
| | (The term “environmental” is used because waste and recycled |
| | materials are utilized in the product) |
| Binder ingredients | 1. Calcined magnesite (magnesium oxide) |
| | (dry powder - between approximately 87%-97% purity with an |
| | approximate sieve size of 325 mesh) |
| | 2. Magnesium chloride hexahydrate |
| | (dry crystal or pulverized powder form - high purity 46% to 50%) |
| Filler materials | Bottom ash or clinker from coal fired power stations also foundry |
| | clinker (fly ash may also be used as a filler, but is not preferred). |
| | Blended ash/clinker specifically proportioned and classified into |
| | specific portions of pulverized powder having 16, 30, 60 and 90 |
| | grit sizes. |
| Fiber materials | E-glass fiber |
| | Alkali Resistant glass fiber |
| | Kenaf, jute or hemp natural fibers from 1 mm to 10 mm in length, |
| | Polypropylene fiber |
| | Polyolefin fiber |
| | Metal fiber |
| | Different configurations of fibers are used depending on the |
| | desired properties of the mix |
| Manufacturing | 1. Bottom ash is processed through a grinding mill or vortex |
| process | crusher or other recognized industry pulverization process and |
| | ground into a fine powder (fly ash may also be used). |
| | 2. Magnesium oxide (MgO) is blended with magnesium chloride |
| | hexahydrate (MgCl) at a ratio of 1.0 parts MgO to 0.6 parts |
| | MgCl. |
| | 3. Bottom ash powder is blended to the MgO/MgCl mix at a ratio |
| | of 2.0 to 10.0 parts bottom ash to 1.0 parts MgO. |
| | 4. A single type of fiber or blend of fibers (as noted above) are |
| | blended with the mix at a ratio between 99.75% product mix |
| | to 0.25% fiber and 91.0% product mix and 9.0% fiber based on |
| | weight. |
| | 5. Each 50 lb. bag of product requires potable water to be mixed |
| | thoroughly to the mix on site by the customer to achieve the |
| | desired consistency for application. |
| | 6. The ingredients are retained in silos or are suspended in super |
| | sacks or bulk bags from weight loss metered machines that |
| | dose and mechanically move the materials that deliver the dry |
| | materials to a mixer. After appropriate mixing, fiber is blended |
| | into the mix as it is being directed into bags. The bags are |
| | sealed for shipping and delivery to customers. Potable water is |
| | mixed with the product on site by the customer. |
| Product | 1. Product is produced from environmentally friendly and |
| advantages | recycled materials - likely to qualify as LEED approved |
| | building material by U.S. Green Building Council. |
| | 2. Product utilizes bottom ash or clinker, a waste material which |
| | has already been burned making it non-combustible and |
| | fire resistant. |
| | 3. High tensile strength allows it to be applied and stick to |
| | numerous substrates. |
| | 4. Can be mixed to achieve a compressive strength of about 9,000 |
| | PSI - rather than 400 to 1,800 PSI typical of conventional |
| | stucco products. |
| | 5. When properly mixed and applied, the product has |
| | significantly less shrinking and cracking than traditional |
| | stucco or flooring products. |
| | 6. When properly mixed and applied, the product has a workable |
| | curing time between one and four hours and high early |
| | strengths allowing traffic to walk on the material quicker than |
| | conventional concrete when used as flooring. |
| | 7. When properly mixed and applied, the product can be sprayed |
| | or troweled as a true one-coat application (rather than 2 or 3 |
| | coats for most traditional stucco products) for smooth and |
| | textured finishes. |

### EXAMPLE III

| | |
|---|---|
| Product name | AERATED SILICA SAND MAGNESIUM CEMENT |
| Binder ingredients | 1. Calcined magnesite (Magnesium oxide) |
| | (dry powder - between approximately 87%-97% purity with an |
| | approximate sieve size of 325 mesh) |
| | 2. Magnesium chloride hexahydrate |
| | (dry crystal form or pulverized crystals to form a powder of high |
| | purity about 46% to 50%) |
| Filler materials | 1. Blended silica sand |
| | 2. Protein based surfactant stabilized by Magnesium Chloride |
| | solution (liquid form having a purity of about 29% to 34%) |
| Fiber materials | E-glass fiber |
| | Alkali Resistant fiber |
| | Kenaf, jute or hemp natural fibers from 1 mm to 10 mm in length, |
| | Polypropylene fiber |
| | Polyolefin fiber |
| | (Different configurations of fibers are used depending on the |
| | desired properties of the mix) |
| Manufacturing | 1. Silica sand is blended and prepared to specific sieve specs. |
| process | 2. Magnesium oxide (MgO) is blended with silica sand at a ratio |
| | of 1.0 to 6.0 parts sand to 1.0 parts MgO. |
| | 3. Magnesium Chloride Hexahydrate (MgCl) is blended to the |
| | mix at a ratio of 1.0 parts MgO to 0.6 parts MgCl. |
| | 4. A single type of fiber or blend of fibers (as noted above) are |
| | blended with the mix at a ratio between 99.75% StuccoMax |
| | mix to 0.25% fiber and 91.0% StuccoMax mix and 9.0% fiber |
| | based on weight. |
| | 5. Each 50 lb. bag of product requires approximately 7 lbs of |
| | potable water to be mixed thoroughly to the mix on site by the |
| | customer. |
| | 6. The protein surfactant is a concentrate form which is |
| | diluted approximately 30 to 1 with Magnesium chloride |
| | solution with a baume of 22.5 degrees plus or minus 2%. This |
| | diluted liquid is poured into the pressure chamber of a foam |
| | generator and is mixed under pressure with air and passed |
| | through agitators to produce the desired foaming content |
| | which is stabilized by Magnesium Chloride solution. The |
| | foam mix is ejected from the foam generator, weighed or |
| | measured through a densitometer, and mixed in with the |
| | Stucco material to achieve desired densities. |
| | The dry ingredients are retained in silos or are suspended in super |
| | sacks or bulk bags from weight loss metered machines that dose |
| | and mechanically move the materials that deliver the dry materials |
| | to a mixer. After appropriate mixing, fiber is blended into the mix |
| | as it is being directed into bags. The bags are sealed for shipping |
| | and delivery to customers. Potable water and the magnesium |
| | chloride stabilized foaming agent are thoroughly mixed with the |
| | material on site prior to application. |
| Product | 1. Interior and exterior applications |
| advantages | 2. Due to the foaming process the product has high thermal |
| | qualities similar to polystyrene foam and can replace the |
| | polystyrene foam as exterior foam insulating sheathing on |
| | buildings. |
| | 3. Due to the foaming process along with the silica sand as the |
| | filler, the foamed coating is totally non combustible and is a |
| | fire barrier. |
| | 4. Due to the foaming process, the product can be mixed |
| | significantly lighter than other stucco products making the |
| | application process less strenuous when applied with a trowel |
| | and may be applied to thicknesses of 2 inches, far thicker than |
| | conventional stuccos. |
| | 5. Due to the foaming process, the product can be mixed |
| | significantly lighter than other cementious cast products while |
| | still retaining strengths equal to conventional concrete making |
| | the final products lighter to ship or handle. |
| | 6. High tensile strength allows it to be applied and stick to |
| | numerous substrates. |
| | 7. Can be mixed in various densities to achieve a compressive |
| | strength of about 1,800 PSI to over 4,000 PSI - rather than 400 |
| | to 1,800 PSI typical of traditional stucco or casting products. |
| | 8. When properly applied, the product has significantly less |
| | shrinking and cracking than traditional stucco products. |
| | 9. When properly applied, the product has a workable curing |
| | time of two hours. |
| | 10. When properly applied, the product can be sprayed or |
| | troweled as a true one-coat application (rather than 2 or 3 |
| | coats for most traditional stucco products) for smooth and |
| | textured finishes. |

### EXAMPLE IV

| | |
|---|---|
| Product name | Environmental Hybrid |
| | ASH AND SILICA SAND MAGNESIUM CEMENT |
| Binder ingredients | 1. Calcined magnesite (magnesium oxide) |
| | (dry powder - between approximately 87%-97% purity with an |
| | approximate sieve size of 325 mesh) |
| | 2. Magnesium chloride hexahydrate |
| | (dry crystal form or pulverized crystals to form a powder of high |
| | purity) |
| Filler materials | 1. Bottom ash is processed through a grinding mill or vortex crusher |
| | or other recognized industry standards in pulverization and |
| | ground into a fine powder (fly ash may also be used, but is not |
| | preferred). |
| | 2. Silica sand of specifically proportioned and classified into |
| | specific portions of 16, 30, 60 and 90 grit sizes. |
| Fiber materials | Eglass fiber |
| | Alkali Resistant glass fiber |
| | Kenaf, jute or hemp natural fibers from 1 mm to 10 mm in length |
| | Polypropylene fiber |
| | Polyolefin fiber |
| | Metal fiber |
| | (Different configurations of fibers are used depending on the desired |
| | properties of the mix) |
| Manufacturing | 1. Silica sand is blended and prepared to specific sieve specs. |
| process | 2. Bottom ash is run through a grinding mill or vortex grinder or |
| | and ground into a fine powder. |
| | 3. Bottom ash powder is blended with the appropriate silica sand in |
| | a ratio of 3.0 parts bottom ash to 1.0 parts silica sand or 3.0 parts |
| | silica sand to 1.0 parts bottom ash or any combination in |
| | between. |
| | 4. Magnesium oxide (MgO) is blended with the bottom ash/sand |
| | mix at a ratio of 1.0 parts MgO to between 2.0 parts bottom |
| | ash/sand mix up to 10.0 parts to 1.0 parts of MgO. |
| | 5. Magnesium chloride hexahydrate (MgCl) is blended with the |
| | mix at a ratio of 0.6 parts MgCl to 1.0 parts MgO. |
| | 6. A single type of fiber or blend of fibers (as noted above) are |
| | blended with the mix at a ratio between 99.75% product mix to |
| | 0.25% fiber and 91.0% product mix and 9.0% fiber based on |
| | weight. |
| | 7. Each 50 lb. bag of hybrid product requires approximately 7.2 lbs. |
| | of potable water to be mixed thoroughly to the mix on site by |
| | the customer. |
| | The dry ingredients are retained in silos or are suspended in super |
| | sacks or bulk bags from weight loss metered machines that dose and |
| | mechanically move the materials that deliver the dry materials to a |
| | mixer. After appropriate mixing, fiber is blended into the mix as it |
| | is being directed into bags. The bags are sealed for shipping and |
| | delivery to customers. Potable water is thoroughly mixed with the |
| | material on site prior to application. |
| Product | 1. Product is produced from environmentally friendly and recycled |
| advantages | materials - likely to qualify as LEED approved building material |
| | by U.S. Green Building Council. |
| | 2. Product utilizes bottom ash or clinker, a waste material which |
| | has already been burned and becomes totally non combustible |
| | and fire resistant. |
| | 3. High tensile strength allows it to be applied and stick to |
| | numerous substrates. |
| | 4. Can be mixed to achieve 9,000 PSI - rather than 400 to 1,800 |
| | PSI typical of traditional stucco products. |
| | 5. When properly mixed and applied, has significantly less |
| | shrinking and cracking than traditional stucco or flooring |
| | products. |
| | 6. When properly mixed and applied, has a workable curing time of |
| | two hours and high early strengths allowing traffic to walk on |
| | the material quicker than conventional concrete when used as |
| | flooring. |
| | 7. When properly mixed and applied, can be sprayed or troweled as |
| | a true one-coat application (rather than 2 or 3 coats for most |
| | traditional stucco products) for smooth and textured finishes. |

### EXAMPLE V

| | |
|---|---|
| Product name | Environmental AERATED ASH MAGNESIUM CEMENT |
| Binder ingredients | 1. Calcined magnesite (magnesium oxide) |
| | (dry powder - between approximately 87%-97% purity with an |
| | approximate sieve size of 325 mesh) |
| | 2. Magnesium chloride hexahydrate |
| | (dry crystal form or pulverized crystals to form a powder of high |
| | purity about 46% to 50%) |
| Filler materials | 1. Bottom ash is processed through a grinding mill or vortex |
| | crusher or other recognized industry standards in pulverization and |
| | ground into a fine powder (fly ash may also be used, but is not |
| | preferred). |
| | 2. Protein based surfactant stabilized by Magnesium Chloride |
| | solution (liquid form) |
| Fiber materials | Eglass fiber |
| | Alkali Resistant glass fiber |
| | Kenaf, jute or hemp natural fibers from 1 mm to 10 mm in length, |
| | Polypropylene fiber |
| | Polyolefin fiber |
| | Metal fiber |
| | (Different configurations of fibers are used depending on the |
| | desired properties of the mix) |
| Manufacturing | 1. Bottom ash is processed through a grinding mill or vortex |
| process | crusher or other recognized industry standards in pulverization |
| | and ground into a fine powder (fly ash may also be used). |
| | 2. Magnesium oxide (MgO) is blended with magnesium chloride |
| | Hexahydrate (MgCl) at a ratio of 1.0 parts MgO to 0.6 part |
| | MgCl. |
| | 3. Bottom ash powder is blended to the Mgo/MgCl mix at a ratio |
| | of 2.0 parts to 10.0 parts bottom ash to 1.0 parts MgO. |
| | 4. A single type of fiber or blend of fibers (as noted above) are |
| | blended with the mix at a ratio between 99.75% product mix to |
| | 0.25% fiber and 91.0% product mix and 9.0% fiber based on |
| | weight. |
| | 5. Each 50 lb. bag of product requires approximately 7 lbs of |
| | potable water to be mixed thoroughly to the mix on site by the |
| | customer. |
| | 6. The protein surfactant is a concentrate form which is |
| | diluted approximately 30 to 1 with magnesium chloride |
| | solution with a baume of 22.5 degrees, plus or minus 2%. This |
| | diluted liquid is poured into the pressure chamber of a foam |
| | generator and is mixed under pressure with air or CO2 and |
| | passed through agitators to produce the desired foaming |
| | content. The foam mix is ejected from the foam generator, |
| | weighed or measured through a densitometer, and mixed in |
| | with the StuccoMax-E material to achieve desired densities. |
| | The dry ingredients are retained in silos or are suspended in super |
| | sacks or bulk bags from weight loss metered machines that dose |
| | and mechanically move the materials that deliver the dry materials |
| | to a mixer. After appropriate mixing, fiber is blended into the mix |
| | as it is being directed into bags. The bags are sealed for shipping |
| | and delivery to customers. Potable water and the magnesium |
| | chloride stabilized foaming agent are thoroughly mixed with the |
| | material on site prior to application. |
| Product | 1. Product is made out of environmentally friendly and recycled |
| advantages | materials - likely to qualify as LEED approved building |
| | material by U.S. Green Building Council. |
| | 2. Product utilizes modified bottom ash or clinker - to the best of |
| | our knowledge, no other product utilizes this waste material. |
| | 3. Product has Interior and exterior applications. |
| | 4. Due to the foaming process the product has very high thermal |
| | qualities similar to polystyrene foam and may be used to |
| | replace the polystyrene foam as exterior foam insulating |
| | sheathing on buildings. |
| | 5. Due to the foaming process along with the already burned ash |
| | as the filler, the foamed coating is totally non combustible and |
| | is a fire barrier making the coating ideally suited to cover |
| | wood roof sheathing prior to the application of roof tiles. |
| | When used as a roof coating, it is possible to nail and screw |
| | into the material as the density has been significantly reduced |
| | and actually performs similar to wood when nailed. |
| | 6. Due to the foaming process, the product can be mixed |
| | significantly lighter than other stucco or cement products |
| | making the application process less strenuous when applied |
| | with a trowel and may be applied to thicknesses of 2 inches, |
| | far thicker than conventional stuccos or cements. |
| | 7. High tensile strength allows it to be applied and stick to |
| | numerous substrates. |
| | 8. Can be mixed to achieve over 3,000 PSI - rather than 400 to |
| | 1,800 PSI typical of traditional stucco products. |
| | 9. When properly applied, has significantly less shrinking and |
| | cracking than traditional stucco products. |
| | 10. When properly applied, has a workable curing time of two |
| | hours. |
| | 11. When properly mixed and applied, can be sprayed or troweled |
| | as a true one-coat application (rather than 2 or 3 coats for |
| | most traditional stucco products) for smooth and textured |
| | finishes. |

### EXAMPLE VI

| | |
|---|---|
| Product name | Environmental Hybrid AERATED ASH and SILICA SAND |
| | MAGNESIUM CEMENT |
| Binder ingredients | 1. Calcined magnesite (magnesium oxide) |
| | (dry powder - between approximately 87%-97% purity with an |
| | approximate sieve size of 325 mesh) |
| | 2. Magnesium chloride Hexahydrate |
| | (dry crystal form or pulverized crystals to form a powder of high |
| | purity about 46% to 50%) |
| Filler materials | 1. Bottom ash or clinker from coal fired power stations also foundry |
| | clinker. |
| | (fly ash may also be used, but is not preferred) |
| | 2. Silica sand |
| | 3. Protein based surfactant (liquid form). One such surfactant found |
| | suitable is derived from tropical plants. |
| Fiber materials | Eglass fiber |
| | Alkali Resistant glass fiber |
| | Kenaf, jute or hemp natural fibers from 1 mm to 10 mm in length, |
| | Polypropylene fiber |
| | Polyolefin fiber |
| | Metal fiber |
| | (Different configurations of fibers are used depending on the desired |
| | properties of the mix) |
| Manufacturing | 1. Silica sand is blended and prepared to specific sieve specs. |
| process | 2. Bottom ash is processed through a grinding mill or vortex |
| | crusher or other recognized industry standards in pulverization |
| | and ground into a fine powder (fly ash may also be used). |
| | 3. Bottom ash powder is blended with the appropriate silica sand in |
| | a ratio of 3.0 parts bottom ash to 1.0 parts silica sand to 1.0 parts |
| | bottom ash to 3.0 parts silica sand. |
| | 4. Magnesium oxide (MgO) is blended with the bottom ash/sand |
| | mix at a ratio of 1.0 parts MgO to between 2.0 parts and 10.0 |
| | parts bottom ash/sand mix. |
| | 5. Magnesium chloride Hexahydrate (MgCl) is blended with the |
| | mix at a ratio of 0.6 parts MgCl to 1.0 parts MgO |
| | 6. A single type of fiber or blend of fibers (as noted above) are |
| | blended with the mix at a ratio between 99.75% product mix to |
| | 0.25% fiber and 91.0% product mix and 9.0% fiber based on |
| | weight. |
| | 7. Each 50 lb. bag of hybrid product requires approximately 7.2 lbs |
| | of potable water to be mixed thoroughly to the mix on site by the |
| | customer. |
| | 8. The protein surfactant is a concentrate form which is diluted |
| | approximately 30 to 1 with magnesium oxychloride solution |
| | with a baume of 22.5 degrees, plus or minus 2%. This diluted |
| | liquid is poured into the pressure chamber of a foam generator |
| | and is mixed under pressure with air or CO2 and passed through |
| | agitators to produce the desired foaming content. The foam mix |
| | is ejected from the foam generator, weighed or measured |
| | through a densitometer, and mixed in with the StuccoMax-E |
| | material to achieve desired densities. |
| | The dry ingredients are retained in silos or are suspended in super |
| | sacks or bulk bags from weight loss metered machines that dose and |
| | mechanically move the materials that deliver the dry materials to a |
| | mixer. After appropriate mixing, fiber is blended into the mix as it |
| | is being directed into bags. The bags are sealed for shipping and |
| | delivery to customers. Potable water and the magnesium chloride |
| | stabilized foaming agent are thoroughly mixed with the material on |
| | site prior to application. |
| Product | 1. Product is made out of environmentally friendly and recycled |
| advantages | materials - likely to qualify as LEED approved building material |
| | by U.S. Green Building Council |
| | 2. Product utilizes modified bottom ash or clinker - to the best of |
| | our knowledge, no other product utilizes this waste material |
| | 3. Products have Interior and exterior applications. |
| | 4. Due to the foaming process the product has very high thermal |
| | qualities similar to polystyrene foam and may replace the |
| | polystyrene foam as exterior foam insulating sheathing on |
| | buildings. |
| | 5. Due to the MgCl and CO2 foaming process along with the |
| | already burned ash as the filler, the foamed coating is totally non |
| | combustible and is a fire barrier. As such, it can be used as a |
| | coating over roofing sheathing prior to the application of roofing |
| | materials and tiles which creates a fire barrier by protecting the |
| | wood sheathing beneath the roof tiles. |
| | 6. Due to the foaming process, the material is less dense and can be |
| | easily nailed or screwed into which also makes this an ideal |
| | substrate to roofing tiles. |
| | 7. Due to the foaming process, the product can be mixed |
| | significantly lighter than other stucco or cement products making |
| | the application process less strenuous when applied with a trowel |
| | and may be applied to thicknesses of 2 inches, far thicker than |
| | conventional stuccos or cements. |
| | 8. High tensile strength allows it to be applied and stick to |
| | numerous substrates |
| | 9. Can be mixed to achieve over 3,000 PSI - rather than 400 to |
| | 1,800 PSI typical of traditional stucco products. |
| | 10. When properly applied, has significantly less shrinking and |
| | cracking than traditional stucco products. |
| | 11. When properly applied, has a workable curing time of two |
| | hours. |
| | 12. When properly mixed and applied, can be sprayed or troweled |
| | as a true one-coat application (rather than 2 or 3 coats for most |
| | traditional stucco products) for smooth and textured finishes. |

In the examples above, the calcined magnesium oxide has a purity in the approximate range of between 87% to 97%. The dry powder is fine, similar to flour with a sieve size of approximately 325 mesh.

It will be obvious to those skilled in the art to make various changes, alterations and modifications to the invention described herein. To the extent such changes, alterations and modifications do not depart from the spirit and scope of the appended claims; they are intended to be encompassed therein.

I claim:

1. A method of preparing a cementitious composition for application to surfaces comprising:
(a) blending MgO with a filler in a ratio of one part MgO by weight to between 1.0 to 6.0 parts filler to form a mixture; and
(b) blending the mixture with magnesium chloride in a ratio of about 1.0 part MgO to between 0.1 to 1.2 parts by weight magnesium chloride.

2. The method of claim 1 wherein the filler is selected from the group consisting of silica sand, recycled aggregates from concrete or river/sea silt, clinkers or bottom ash or fly ash in natural found form and clinkers or bottom pulverized to predetermined sieve sizes.

3. The method of claim 1 wherein a fiber is combined with the mixture.

4. The method of claim 3 wherein the fiber is selected from the group consisting of glass fiber, alkaline resistant fiber, polypropylene fiber and polyolefin fiber, Kenaf, jute or hemp natural fibers from 1 mm to 10 mm in length.

5. The method of claim 1 wherein the filler is clinker or bottom ash and is blended at a ratio of approximately 1.0 MgO to between 1-6 parts bottom ash.

6. The method of claim 5 wherein the clinker or bottom ash is processed in a grinding mill or a vortex grinder and resized down to specific sieve sizes.

7. A method of preparing a composition for application to as surface comprising:
(a) blending MgO with a filler in a ratio of one part MgO by weight to between 1.0 to 6.0 parts filler to form a mixture;
(b) blending the mixture with magnesium chloride in a ratio of about 1.0 part MgO to between 0.6 to 1.2 parts by weight magnesium chloride; and
(c) importing a foamed surfactant into the mixture which can also be stabilized by Magnesium Chloride solution.

8. The method of claim 7 wherein the surfactant is a protein based surfactant with superior mechanical performance.

9. The method of claim 8 wherein the surfactant is in concentrated form and is diluted with magnesium chloride solution and is mixed with air or CO2 gas in a foam generator and introduced into the mixture.

10. The method of claim 1 wherein the mixture is prepared for application by mixing with water to a predetermined viscosity.

11. The method of claim 10 wherein about 5 to 10 pounds of water are added to about 50 pounds of composition.

12. A cementitious composition for use in application to surfaces comprising:
(a) a first part comprising calcined magnesite (MgO) in dry powder form; and
(b) a second part comprising magnesium chloride hexahydrate in pulverized powder or dry crystal form to form a mixture.

13. The cementitious composition of claim 12 further including a filler selected from the group consisting of silica sand, silt, fly ash, bottom ash or clinker in pulverized or natural form

14. The cementitious composition of claim 12 further including fiber selected from the group consisting of glass fiber, alkali resistant glass fiber, polypropylene fiber, polyolefin fiber or metal fiber or kenaf, jute, hemp or natural grasses fibers.

15. The cementitious composition of claim 12 wherein the mixture is foamed by the addition of a surfactant.

16. The cementitious composition of claim 15 wherein the surfactant is a liquid protein and stabilized by magnesium chloride solution.

17. The cementitious composition of claim 12 wherein the ratio of MgO to MgCI is about between 1:1 to about 3:1 by weight.

18. The method of claim 1 wherein the dry ingredients are separately stored and metered quantities are delivered to a mixer to form a mixture.

19. The method of claim 1 wherein fiber is added to the mixture and the resulting products is bagged.
